(19) United States
(12) Patent Application Publication
(10) Pub. No.: US 2026/0246755 A1
(43) Pub. Date: Aug. 20, 2026

(54) INTERCOM MESSAGING SYSTEM

(71) Applicant: A-DEC, INC., Newberg, OR (US)

(72) Inventors: Joseph David GILLIS, Newberg, OR (US); Steven Anthony QUINN, Newberg, OR (US); Ryan Douglas BECKHAM, Newberg, OR (US); Lee David HILLS, Sherwood, OR (US); Spencer Thomas WARNEKE, Brush Prairie, WA (US); Geoffrey Schuyler GOODMAN, Tualatin, OR (US); Spenser Matthew BRAY, Newberg, OR (US); Ryan Michael WILLIAMS, Sherwood, OR (US)

(21) Appl. No.: 19/540,467

(22) Filed: Feb. 13, 2026

Related U.S. Application Data
(60) Provisional application No. 63/759,978, filed on Feb. 18, 2025.

(51) Int. Cl. H04L 51/52; G06Q 10/107; H04L 9/40; H04L 51/18; H04L 51/212; H04L 51/214; H04L 67/12; H04W 4/14

(52) U.S. Cl. CPC H04L 51/52; G06Q 10/107; H04L 51/18; H04L 51/212; H04L 51/214; H04L 63/08; H04L 67/12; H04W 4/14

(57) ABSTRACT

Embodiments herein relate to methods and apparatuses for communicating in a dental office. The solutions provide simplified cross-platform communications within an office through standardized messages that work across different types of dental equipment, mobile devices and computers, to allow messages to be received by the appropriate staff member at the right place and time with minimal intrusion. The messages can automatically identify the sending location and sender and provide a custom menu of message options. Messages can also be sent automatically.

### CROSS-REFERENCE TO RELATED APPLICATIONS

This application claims the benefit of U.S. provisional patent application No. 63/759,978, filed Feb. 18, 2025, entitled “Intercom Messaging System,” and incorporated herein by reference.

### TECHNICAL FIELD

Embodiments herein relate to methods and apparatuses for communicating in a dental office.

### BACKGROUND

Dental offices seek to improve workflow and client service by facilitating communications among staff members of the practice. Staff members communicate for tasks such as notifying a clinician that a patient has been prepared for a procedure or notifying a staff member that an operatory needs to be cleaned and/or replenished with supplies. However, various challenges are presented in that the staff members are in different rooms of the office as well as by factors such as the desire to work efficiently, avoid unnecessary interruptions and maintain patient privacy.

### BRIEF DESCRIPTION OF THE DRAWINGS

Embodiments will be readily understood by the following detailed description in conjunction with the accompanying drawings and the appended claims. Embodiments are illustrated by way of example and not by way of limitation in the figures of the accompanying drawings.

FIG. 1 depicts an example communication system 100, in accordance with various embodiments.

FIG. 2 depicts an example of practice management software 190 for use in the communication system 100, in accordance with various embodiments.

FIG. 3 depicts an example computing device 195, in accordance with various embodiments.

FIG. 4 depicts an example user interface (UI) device 400 associated with equipment in the communication system 100, in accordance with various embodiments.

FIG. 5 depicts examples of portable UI devices in the communication system 100, in accordance with various embodiments.

FIG. 6 depicts an example UI 600 associated with the personal computer (PC) 170 in the communication system 100, in accordance with various embodiments.

FIG. 7 depicts an example message format, in accordance with various embodiments.

FIG. 8 depicts another view of an example communication system 800, in accordance with various embodiments.

FIG. 9 depicts an example of information in the ecosystem 810 of FIG. 8, in accordance with various embodiments.

FIG. 10 depicts an example implementation of a communication system 700, in accordance with various embodiments.

### DETAILED DESCRIPTION OF DISCLOSED EMBODIMENTS

In the following detailed description, reference is made to the accompanying drawings which form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

The description may use perspective-based descriptions such as up/down, back/front, and top/bottom. Such descriptions are merely used to facilitate the discussion and are not intended to restrict the application of disclosed embodiments.

The terms “coupled” and “connected,” along with their derivatives, may be used. It should be understood that these terms are not intended as synonyms for each other. Rather, in particular embodiments, “connected” may be used to indicate that two or more elements are in direct physical contact with each other. “Coupled” may mean that two or more elements are in direct physical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

As mentioned at the outset, various challenges are presented in facilitating communications among staff members of a dental practice or other medical practice.

One approach involves face-to-face communications. While this is a direct form of communication, it can be time-consuming and may not be feasible when a staff member is not immediately available or should not be interrupted. Another approach involves the staff members wearing radio headsets to communicate with one another. However, this can be uncomfortable and interfere with the staff member's movement. Another approach is a paging system where a page is broadcast throughout an office. Another approach involves a light that can be turned on by a remote switch, e.g., to indicate that a patient is ready to be seen. Another approach is to use wireless communication devices such as smart phones, but these are not integrated into the office and its equipment, and therefore do not allow for automation and leveraging of clinic intelligence such as a scheduling system and patient and staff profiles. The above approaches also do not allow for equipment-based communications.

Another challenge is that office communications can be inconvenient and broken up across different systems and user interfaces. This causes coordinated activities to take too long and require unnecessary intervention.

Another challenge is integrating across internal and external communications platforms so that the user is not limited to a given communications platform of an office.

The solutions provided herein address the above and other issues. The solutions provide an integrated approach to consolidate operations-based communications into a familiar format that can be accessed on the dental equipment interfaces that are already is use as well as on mobile devices and other computers.

In one aspect, the solutions provide simplified cross-platform communications within an office through standardized messages that work across different types of dental equipment, mobile devices and computers, to allow messages to be received by the appropriate staff member at the right place and time with minimal intrusion.

In another aspect, the solutions allow access to the same information in multiple locations, as the information is synchronized across all platforms.

The solutions can integrate communications across multiple platforms and personal computer (PC) applications to provide a consistent experience.

The solutions can include messages that are used in automation recipes to trigger other environmental actions like supplemental notification light systems. Messages can be triggered from automation recipes to let users know of critical equipment alerts such as a low vacuum pressure.

The above and other features can be understood further in view of the following discussion.

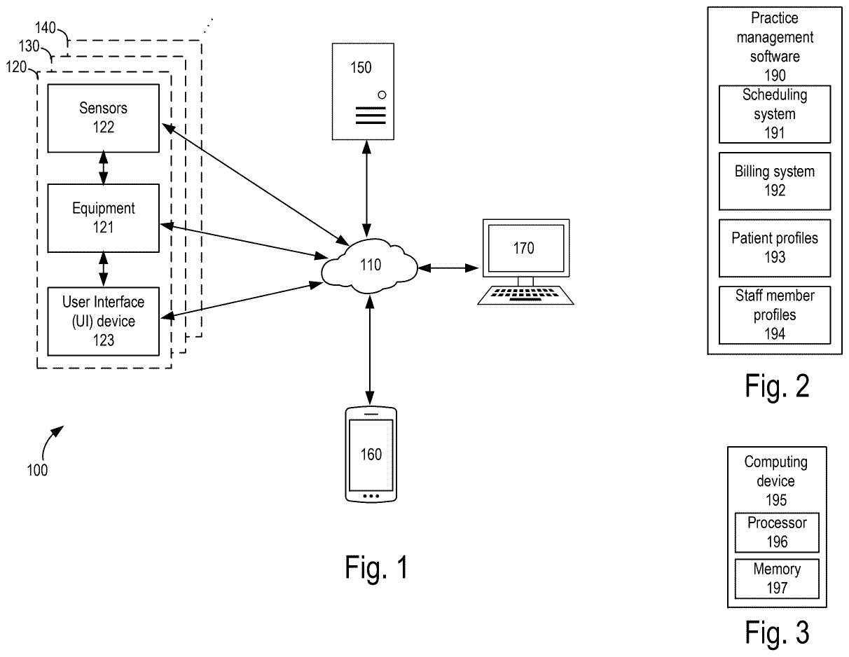

FIG. 1 depicts an example communication system 100, in accordance with various embodiments. The communication system includes a network cloud 110 that can represent a local-area network such as within a dental office and/or a wide-area network such as the Internet. In this example, a dental office has multiple operatories 120, 130, and 140, typically separate rooms or partitioned areas where patients are served. The dental office can also include a front desk/reception area where patients are checked in, a business office area for an administrator who performs billing and other administrative tasks, a private office area for a dentist, a sterilization room, and a break room.

Each operatory can include equipment 121 such as delivery systems, patient chairs, handpiece systems, operatory lights, and a control center, typically housed in a cabinet. An operatory can further include sensors 122. This can include sensors associated with the equipment, such as a sensor in a chair that detects whether a patient is sitting in the chair, and sensors separate from the equipment, such as a motion sensor that detects whether there is anyone in an operatory.

An operatory can further include a user interface (UI) device 123, which can be associated with equipment, e.g., attached to or built into the equipment, or separate from the equipment, such as a standalone tablet or other screen.

The communication system 100 further includes a server 150 with software for storing data for the practice management software 190. The server can be a separate dedicated computing device or the server functionality can be incorporated into another computing device such as the personal computer (PC) 170. In another approach, the UI devices of an office are in a peer-to-peer local area network which does not have a central server.

The communication system 100 further includes an example of a portable UI device 160 such as a smart phone and a PC 170 such as might be used at the front desk or administration area of the office.

FIG. 2 depicts an example of practice management software 190 for use in the communication system 100, in accordance with various embodiments. The software can run on the various devices in the network. In one approach, the software runs using a client-server model. The practice management software 190 includes a scheduling system 191 that includes information such as scheduled dates and times of patient visits and types of procedures that are planned. A billing system 192 can track amounts owed by patients and whether they are significantly past due. Patient profiles 193 can include information and preferences of individual patients, and staff member profiles 194 can include information and preferences of individual staff members, as described herein.

FIG. 3 depicts an example computing device 195, in accordance with various embodiments. The computing device can represent any of the devices in FIG. 1 including the UI device 123, the server 150, the PC 170 and the portable UI device 160. The computing device can include any combination of hardware or software which is configured to provide the features described herein. The computing device 195 includes a memory 197 configured to store instructions and a processor 196 configured to execute the instructions to provide the features described herein. The memory may be a tangible, non-transitory storage medium. One or more processors and one or more storage mediums may be used. The computing device may be used to perform computer-implemented methods to provide the features described herein.

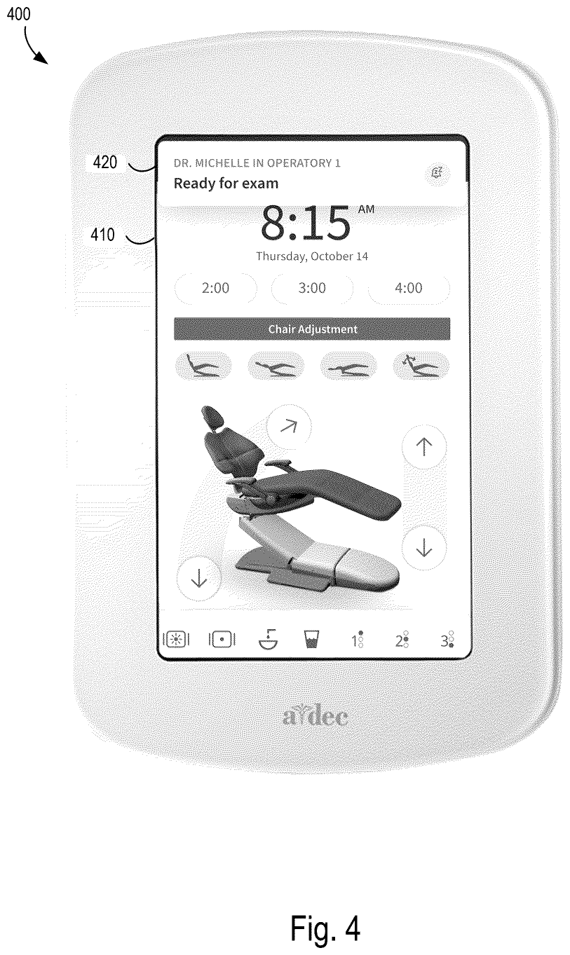

FIG. 4 depicts an example user interface (UI) device 400 associated with equipment in the communication system 100, in accordance with various embodiments. The UI device may be associated with a patient chair, for example. The UI device includes a touchscreen 410 and include preset buttons for adjusting the chair, such as the seat and back angle and the chair height. A top region 420 of the display is a received message: “Dr. Michelle in Operatory 1—Ready for Exam.” This message indicates that Dr. Michelle should go to Operatory 1 to see a patient who is ready for exam. Advantageously, the message can be incorporated into an existing UI device that is used for other purposes, e.g., controlling a chair or other equipment, so that a separate UI device does not have to be provided. The UI device 400 may be in a second operatory, for example, where Dr. Michelle is currently treating another patient.

In one approach, multiple UI devices are associated with an operatory, e.g., one for the dentist and one for the hygienist or other assistant. Different UI devices can be associated with different staff member roles, e.g., dentist, assistant, hygienist, technicians, and office manager. Each UI device can be associated with a different staff member role and generate a menu of messages tailored to the role.

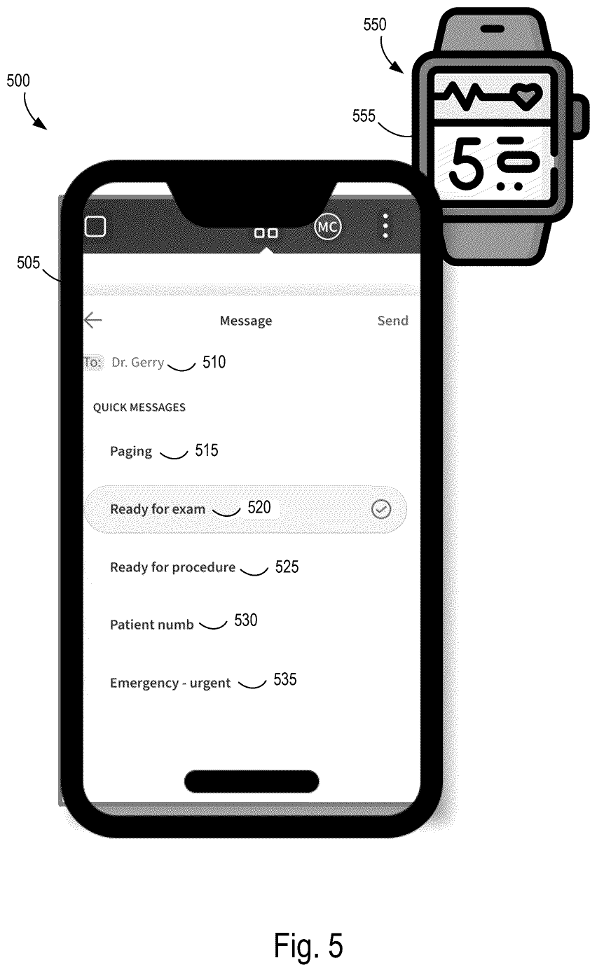

FIG. 5 depicts examples of portable UI devices in the communication system 100, in accordance with various embodiments. The devices include a smart phone 500 with a UI 505 and a smart watch 550 with a UI 555. A UI device can be part of dental equipment, a mobile device such as a smart phone, tablet or smart watch, or a computer such as a laptop or desktop. A UI device can include a display and a touchpad to receive user commands, for example. A UI device could also accommodate audible commands and outputs.

The smart phone UI 505 depicts a message that is being prepared. The “to” field 510 indicates the recipient (“Dr. Gerry”). The sender may select the recipient from a list of staff members, in one approach, using the touch screen of the UI device.

The sender can select from a number of quick messages. These are suggested message that are pre-populated on the display in a menu. They can include: a paging message 515, a ready for exam message 520, a ready for procedure message 525, a patient numb message 530, and an emergency-urgent message 535. In some cases, when an initial selection is made of a suggested message, additional related suggested messages can be displayed that allow the sender to provide further details regarding the initial selection. For example, selection of the “ready for procedure” message may bring up options to describe the type of procedure to be performed. For example: “ready for procedure-crown.”

In one example, a staff member (e.g., user of the communication system) is working on a patient in a first operatory of a dental office. For example, a hygienist may clean a patient's teeth prior to a dentist performing an examination. When the staff member has completed the work, they may send a message using the UI device in the first operatory to a particular dentist such as: “Operatory 1 ready for exam.” The dentist can be selected from a list of available dentists. The available dentists and their locations may be known by their log in to equipment or a computer in the office, or by a Bluetooth presence indicator, for example. In another approach, the message is sent to a group of dentists, any of whom can respond and agree to see the patient. Once one dentist responds, the messages can be deleted or otherwise modified such as by being greyed out to indicate that the message is no longer active.

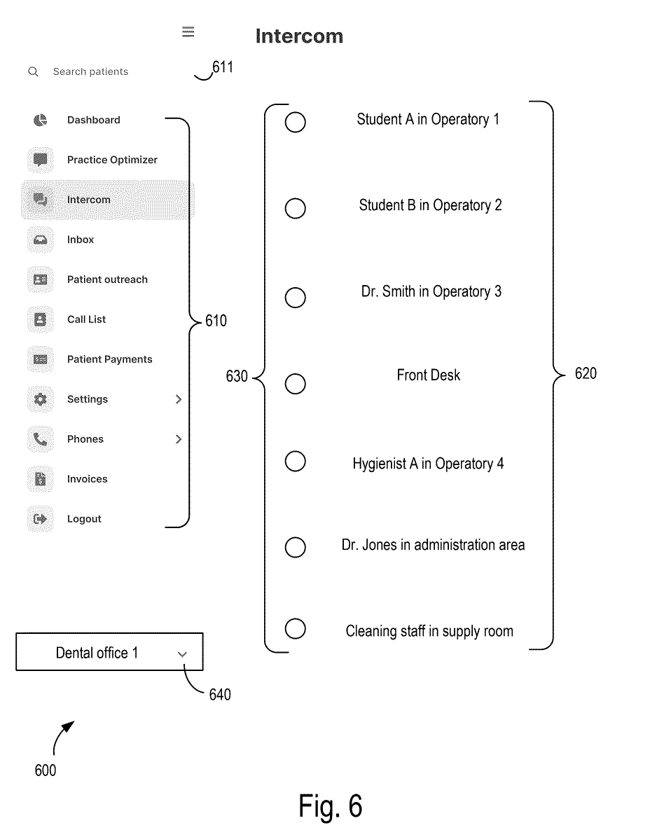

FIG. 6 depicts an example UI 600 associated with the PC 170 in the communication system 100, in accordance with various embodiments. The UI includes a region 610 with different features that can be selected, including: dashboard, practice optimizer, intercom, inbox, patient outreach, call list, patient payments, settings, phones, invoices and logout. A region 611 allows searching of a patient or staff member such as to view and update a profile. A region 620 provides a list of staff members and their locations within the dental office. Presence indicators 630 can be color coded to indicate whether the staff member is logged into a UI device. For example, the first entry, “Student A in Operatory 1,” can be used in a training clinic of a dental school. It indicates that Student A is in the Operatory 1 based, e.g., on the fact that Student A has logged into a UI device in that operatory.

A drop down menu 640 can be selected to identify a dental office from among a plurality of available dental offices. The region 620 can be tailored to the currently selected office.

A presence indicator can also indicate, e.g., whether a staff member is logged into a PC, a UI device at a piece of equipment in an operatory, or just has the communication application running on a mobile phone or other portable device carried on their person.

Logging in to a UI device can include, e.g., manually entering information on a touchpad or manual keypad, facial recognition, or scanning of a staff member's badge using of near-field communications.

In one approach, messages sent to a UI device at a fixed location such as an operatory can be mirrored to a portable, user-carried device such as a smart phone or smart watch, to ensure that a message is seen even if the recipient briefly stepped away from the expected location. In one approach, the mirroring occurs after a delay if the recipient has not acknowledged the message at the initially-targeted UI device. Messages can also be mirrored to a central location such as a PC at the front desk of the office to allow a staff member to monitor the office's activity.

In one approach, a message sent to a first staff member can be resent to a second staff member who is designated as a backup for the first staff member, if the first staff member does not acknowledge/reply to the message within a specified amount of time.

The UI 600 allows a staff member to quickly ascertain the locations and availability of other staff members.

A number of use cases are possible with the communication system.

In an example, a staff member has injected a local anesthetic into a patient's gum to temporarily numb the area prior to other dental work. When the staff member has complete their work, they may send a message such as: “Operatory 1 patient numb.” The message indicates a procedure performed on a patient. Or, the message may simply state: “Operatory 1 patient ready.”

In another example, a staff member has completed x-rays of a patient and may send a message such as: “Operatory 1 x-rays completed.”

In another example, a first staff member has completed working on a patient, who is departing the operatory. The staff member may send a message such as “Operatory 1 ready for cleaning” to one or more staff members who are assigned to clean/sterilize. Another message can involve the need to restock supplies in the operatory. These are examples of servicing an operatory. Another example of servicing involves securing or locking up cabinets or equipment in an operatory such as at the end of the day or during a break time.

In another example, a first staff member has completed working on a patient, who is leaving the operatory. The staff member may send a message such as “Operatory 1 available for next patient” to a front desk staff members who can instruct the next patient to enter the available operatory. The message indicates a state of the operatory.

In another example, the scheduling system is accessed to determine whether a next patient is expected soon in a certain operatory. If no patient is expected soon, a message regarding cleaning/sterilization or restocking, for example, can be delayed. In one approach, a message indicates the amount of time until a next patient is scheduled for an operatory so that the assigned staff member knows how soon to act.

In another example, a message is sent to an office administrator to initiate a billing process when a patient has completed a procedure.

In one approach, the scheduling system is used to determine a priority in which different operatories should be serviced so that an assigned staff member knows the best servicing order. For example, an operatory which is scheduled for use in ten minutes should be serviced before an operatory which is scheduled for use in twenty minutes.

In one approach, a patient profile includes a name of a patient and how they prefer to be addressed. For a child patient, the patient profile can include the names of the child and an accompanying adult. The patient profile can also indicate whether the patient tends to be fearful or has a particular fear of needles, drilling or other tools or procedures. This information can all be conveyed in a message. An example message is: “Patient ready (fear of drilling)” or “Patient ready (high anxiety).” A color coding system could also be used where green, yellow or red denotes an average, slightly fearful or highly fearful patient, respectively. The state of the patient at the time of the visit can also be entered on a UI device by a staff member based on a menu selection or as free-form text. Generally, the staff member has the option to enter a selected message from a menu of available predefined messages, to edit a suggested message using free-form text, e.g., by typing the message using a keypad, or to provide a free-form message which is not based on a predefined or suggested message.

In one approach, a staff member profile includes a name of the staff member and how they prefer to be addressed. The staff member profile can also indicate other preferences in communications. For example, a staff member profile can indicate that the type of information they would like to receive when a patient is ready to be seen. Based on this preference, a staff member preparing a message is prompted to provide the desired type of information. For example, if the receiving staff member prefers a message with a relatively low amount of detail, the sending staff member is prompted by the UI device to prepare a corresponding message. An example of such a message is: “Patient is ready be seen.”

If the receiving staff member prefers a message with a relatively high amount of detail, the sending staff member is prompted by the UI device to prepare a corresponding message. For example, the sending staff member may initially select the low-detail message: “Patient is ready be seen.” The UI device then prompts the sending staff member to provide additional details such as the type of procedure performed and the patient's state of mind. An example message with a relatively high amount of detail is: “Patient is ready be seen. Has completed cleaning and x-rays. Patient appears calm.” The sending staff member can also be prompted to indicate a reason for the patient's visit, e.g., “Patient returned to office due to problem with previous work” and “Previous type of work is crown.”

In another example, the scheduling information indicates a type of procedure that a patient is to undergo and this is used to guide the type of messages that are available. For example, the messages may be associated with different stages of the procedure, such as: “Operatory 1, step 1 of procedure A is completed.”

In another approach, messages are provided to identify the visit number in a sequence of visits and/or a current stage of a multi-visit procedure. For example, for dental implants, the messages can identify whether the current visit is for extraction, implant placement, or fitting the final crown. For dental bridges, the messages can identify whether the current visit is to prepare the adjacent teeth and make impressions, or to fit and cement the permanent bridge. For a crown, the messages can identify whether the current visit is for consultation/examination, tooth preparation/impression, or final placement. For a veneer, the messages can identify whether the current visit is for consultation, preparation, or final application. For orthodontics, the messages can identify whether the current visit is for an initial consultation, planning, application of braces or scanning for aligners, or a regular adjustment visit. For root canal therapy, the messages can identify whether the current visit is an initial visit which provides a temporary filling, or a follow up visit such as to place a permanent crown or filling. For dentures, the messages can identify whether the current visit is for impressions, bite registration, try-ins, or final adjustments.

In one approach, the menu of messages presented in the UI device are based on the identity of the associated operatory, where different operatories are used for different procedures. For example, a hygiene operatory may be used for cleanings, whitening, and imaging, a restorative operatory may be used for more complex cases, such as fillings, root canals, and crowns, a cosmetic operatory may be used for cosmetic treatments, and an orthodontic operatory may be used for orthodontics.

In another example, different messages associated with different procedures have different priorities. For example, if patients A and B in operatories 1 and 2, respectively, are both ready to be seen by a dentist, patient A may have priority if their procedure is more complex or time-sensitive than patient B's procedure. A message may indicate the priority, e.g., high, medium or low priority, to assist the recipient in responding.

Examples of less complex procedures include cleanings, basic fillings, simple extractions, x-rays and teeth whitening. Examples of moderate complexity include root canals, crown placement, and minor gum surgery. Examples of high complexity include wisdom teeth extraction, dental implants, extensive gum surgery (gingivectomy), orthognathic surgery (jaw alignment correction), and maxillofacial surgery (facial bone reconstruction).

The type and/or complexity of a procedure a patient is undergoing can be obtained, e.g., from the scheduling system, from information input to a UI device in the operation at the time of the procedure by a staff member and/or based on the operatory itself. For example, certain operatories may be reserved and equipped for certain types of procedures. The type of procedure and its degree of complexity can also be based on the type of equipment that is in use in an operatory.

In another example, a patient who has returned to the office due to a complication with a previous procedure, or to receive an additional treatment in a multi-step procedure, may have a higher priority. Or, a new patient may have a higher priority than a pre-existing patient. A patient may even have a higher priority based on payment of a fee or membership in an organization.

In one approach, a recipient may receive a list of multiple messages indicating patients or tasks that require attention. The order of the messages in the list can update as new messages are received based on their respective priorities so that the messages are arranged in an order of descending priority, highest priority first. This informs the recipient of which patients or tasks should be addressed first.

A message can indicate whether a patient is using insurance, and a type of the insurance, as this may guide the procedure. For example, a patient using insurance may receive an amalgam filling instead of a higher-cost filling such as composite or porcelain.

A message can indicate a billing status of a patient, such as whether a bill is significantly past due and an amount of the bill. This information can be maintained in a billing system, which along with the scheduling system and patient and staff member profiles, is part of the practice management software.

Different UI devices in different locations of an office may be registered to their respective locations so that a message can automatically include the location from which it was sent. The different UI devices can be associated with respective equipment so that a message can automatically include an identity of the equipment associated with the message.

In one approach, the UI device presents a suggested message to be sent and the staff member has the chance to approve, disapprove or change the suggestion. The suggested message can be in a menu of one or more suggested messages. The UI may prompt a staff member to enter specific details regarding a patient or their procedure. The details can involve, e.g., whether the patient seems fearful of the dental office, and details regarding the type of procedure that has been performed. The UI can present suggested answers that can be selected by a touch on a touchscreen, or a keypad may allow a staff member to type in message details.

The recipient of a message may have the chance to approve, disapprove or change a suggested reply.

Examples of suggested or pre-configured messages include: paging, ready for exam, ready for procedure, patient numb and emergency-urgent. The pre-configured messages can be set based on the identify, preferences and role of the staff member logged in to the UI device, the type of procedure as entered by the staff member into the UI device or obtained from the scheduling system, for instance, and preferences of the message recipient as obtained from the staff member profiles. The pre-configured replies can be set based on the content of the received message, the identify, preferences and role of the staff member sending the message, the type of procedure, and preferences of the message recipient.

Examples of pre-configured replies to messages include: thank you, be there in five minutes, on my way, unavailable, confirmed and busy.

The UI devices can display one or more icons or other information regarding a location of each staff member. For example, the display can indicate that a certain staff member is in a certain operatory, at the front desk of the office, in an administrative area of the office, or in a break room of the office. The display can also indicate that the staff member is not in the office at all. This gives the sender an idea of who should be the recipient of a message.

In one approach, the system does not allow a message to be sent to a staff member who is unavailable, e.g., due to being busy, on a break or out of the office.

In addition to messages that are sent by staff members, messages can be sent automatically from equipment and associated sensors. For example, occupancy sensing devices such as motion sensors can be used to determine whether an operatory or other location has become available for a next patient and this can trigger an automated message such as for servicing or for the next patient to enter. In one approach, an occupancy sensor in a dental chair can determine that a patient has gotten up from the chair and this can trigger an automated message. In one approach, a room motion sensor can determine that an operatory has become unoccupied and send a corresponding message.

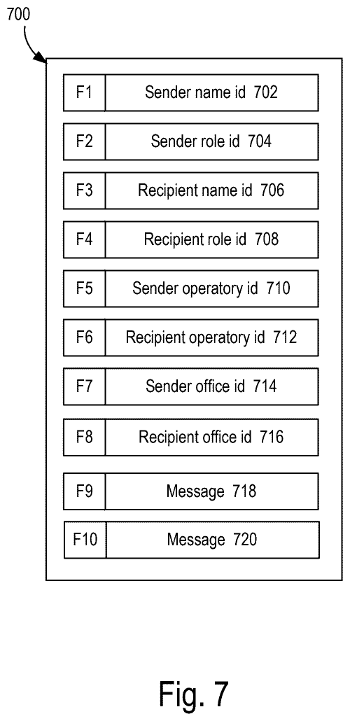

FIG. 7 depicts an example message format, in accordance with various embodiments. The message 700 includes a number of fields identified by F1-F10 and associated payloads. For example, F1 is for a sender name identifier (id) 702, F2 is for a sender role id 704, F3 is for a recipient name id 706, F4 is for a recipient role id 708, F5 is for a sender operatory id 710, F6 is for a recipient operatory id 712, F7 is for a sender office id 714, F8 is for a recipient office id 716, and F9 and F10 are for messages 718 and 720, respectively. Not all of the fields are required and other fields may be used as well. Each field can be allocated a reserved number of bytes and a reserved position in a sequence of fields, in one approach.

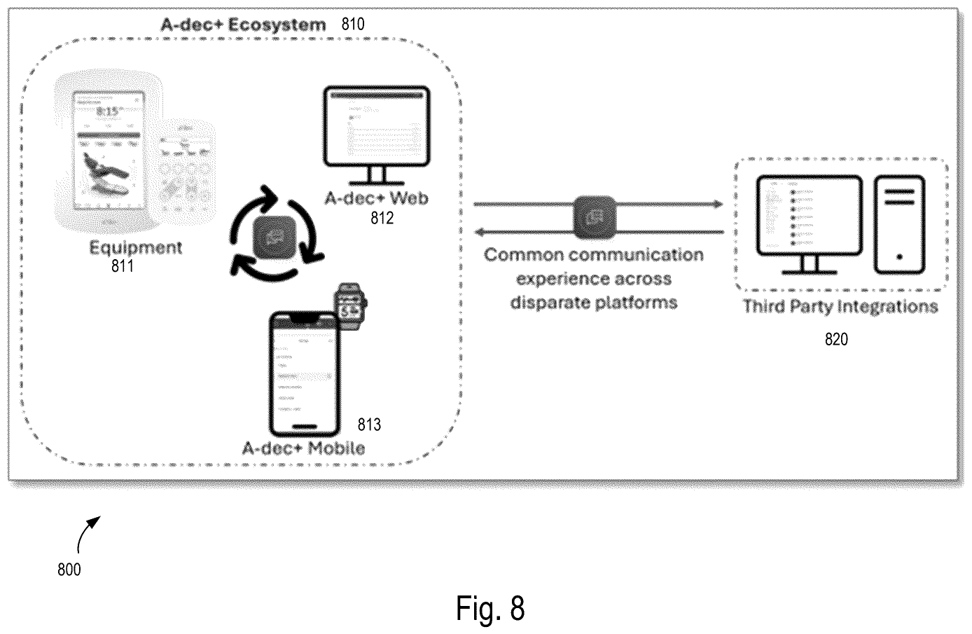

FIG. 8 depicts another view of an example communication system 800, in accordance with various embodiments. An ecosystem 810 includes equipment 811, a PC 812 with a web-based UI and a mobile device 813 with a mobile-based UI. One example of the ecosystem uses the A-dec+ software (available from A-dec, Newberg, Oregon), which is an updatable platform that allows dental practices to connect and monitor their dental equipment, providing access to features like equipment performance data, diagnostics, and software updates. It acts as a central hub to manage and monitor multiple connected devices across a single practice or multi-clinic organization.

The communication system 800 provides a common communication experience across disparate platforms with third-party integrations 820.

In the communication system 800, a communications application is accessible from UI's that allows staff members to conveniently notify one another when assistance is needed. An example UI is A-dec's Pro-Product. These notifications incorporate contextual information from the ecosystem such as sender name, sender location and recipient location. This system also associates users across third party platforms to present a unified message target list, which simplifies the overall interaction for users and makes it possible for messages to get to their intended targets more reliably and with easier overall workflows.

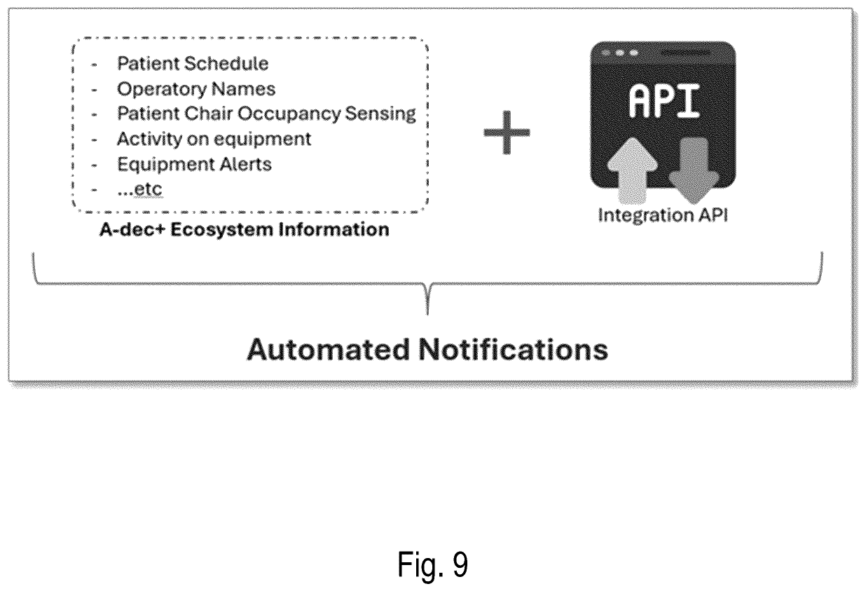

FIG. 9 depicts an example of information in the ecosystem 810 of FIG. 8, in accordance with various embodiments. The information can include: patient schedules, operatory names, patient chair occupancy sensing, activity on the equipment, and equipment alerts. This information can be used by an integration application program interface (API) to provide automatic notifications or messages. In particular, using additional equipment and API information, the system can generate automated messages to get important information to providers and support staff without requiring human interaction.

In a first example, the system sees that an appointment in Operatory #2 is scheduled to end soon, the chair has returned to the entry/exit position and the chair occupancy status switched to vacant. The system then sends a message to support staff that a patient will need help at the front desk and that Operatory #2 needs to be turned over, e.g., by cleaning and/or checking and restocking inventory.

In one approach, an inventory of consumable items can be automatically tracked using RFID devices, and a message can be automatically sent to a staff member when the inventory is low, identifying the item needed and the location, to allow the staff member to restock the item. The inventory tracking messages can also be used to reorder items from suppliers.

In one approach, a message can indicate that a kit of items for a certain procedure is needed. For example, in some cases, the dentist may determine during the course of a procedure or examination that a certain kit is needed and send a message requesting that kit to a staff member who has the role of responding.

In a second example 2, the system sees that the vacuum pressure has dropped below the minimum required level and activates an alert. The system also sees that Operatory #1 and #4 are in use, so it sends an alert to those active UI's to notify the user that there is a system issue that will impact their work in progress. It also notifies the office administrator that service is urgently needed.

Generally, the communication system allows for the secure communication of messages between multiple platforms, including different users or profiles within the ecosystem, and with users of a third-party integrated messaging system. These messages can be targeted to specific individuals, or broadcast to a full recipient list of known and related recipients.

These messages, the list of recipients that they can send a message to, and the status of those recipients (online vs. offline) can be event-based, meaning they are related to where they need to go as fast as the system can process the event. Individuals will receive messages virtually instantaneously after they are sent, and UI devices and the partner systems of the third-party messaging systems are notified immediately when recipients and their statuses change.

There can be multiple sets of potential recipients including those natively created by the cloud platform (e.g., users and profiles) and those provided via third-party integrations (partner systems). In the cloud, the software allows the storage of those as separate recipient lists and allows individuals in different lists to be linked to each other. What this allows is for an individual to have a user account or profile within the ecosystem and the third-party system, but within the ecosystem application, they are presented as a single recipient of a message. When receiving a message, the system will determine which platforms the recipient can receive it at and send it to all of them, in one approach. When sending a message, the sender does not have to know where the recipient is located or direct the message to a specific platform. Instead, they only need to know that they want to send the message to a certain recipient, and the system will route the message where it needs to go to get to the individual and provide a synchronized Inbox experience.

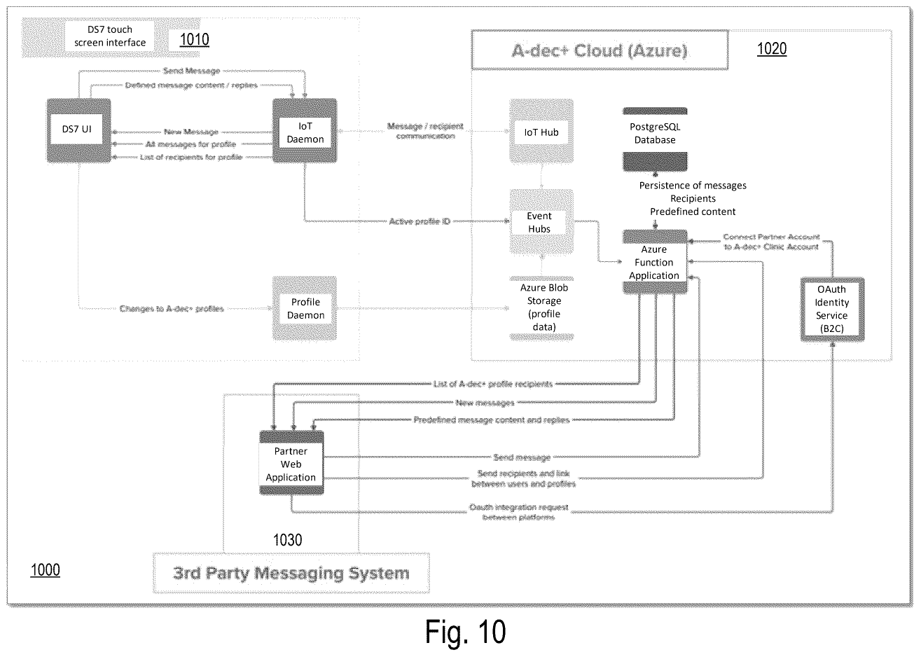

FIG. 10 depicts an example implementation of a communication system 1000, in accordance with various embodiments. The communication system includes a touch screen interface 1010, a cloud computing platform 1020 and a third-party messaging system 1030.

One example of the touch screen interface is the A-dec DS7. The touch interface includes a user interface (UI) display, an Internet of Things (IoT) daemon (a computer program that runs as a background process), and a Profile Daemon. The UI sends messages and defined message content and replies to the IoT daemon. The IoT daemon sends a new message, all messages for a profile, and a list of recipients for a profile, to the UI. The UI also sends changes to profiles to the Profile Daemon.

One example of the cloud computing platform is Microsoft Azure. An IoT Hub communicates with the IoT daemon of the interface 1010 to exchange messages and recipient communications (e.g., responses to new messages). For example, the Azure IoT Hub is a cloud-based service that allows devices to communicate with IoT applications. It can connect millions of devices and their backend systems.

An Event Hubs receives an active profile ID from the IoT daemon, and an Azure Blob Storage receives profile data from the Profile Daemon of the interface 1010. Azure Blob Storage is a cloud-based service for storing data in large quantities. For example, the Azure Event Hubs is a native data-streaming service in the cloud that can stream millions of events per second, with low latency, from any source to any destination.

An Azure function application receives an input from the Event Hubs and communicates with a PostgreSQL database, an example of an open-source database system that supports Structured Query Language (SQL) and JavaScript Object Notation (JSON) querying. Their communications include persistence of messages, recipients and predefined content.

The Azure Function Application can provide outputs including a list of profile recipients, new messages, and predefined message content and replies, to a partner web application at the third-party messaging system 1030.

The Azure Function Application also receives data to connect a partner account to the clinic account from a OAuth Identity Service (business-to-consumer or B2C). This is an example of an authorization framework that lets users grant third-party access to their accounts without sharing their passwords.

The Azure Function application is a serverless compute service provided by Microsoft Azure that allows developers to run small pieces of code (“functions”) without needing to manage underlying infrastructure, triggered by events like HTTP requests, database updates, or messages in a queue,

In the third-party messaging system 1030, the partner web application sends messages and sends recipients and links between users and profiles to the Azure Function Application. The partner web application also sends an OAuth integration request between platforms to the OAuth Identity Service. Examples of third-party messaging systems include Apple iMessage, Facebook Messenger, and WeChat.

The components of the communication system 1000 are discussed in further detail below in an example implementation.

DS7 UI: this software resides on the DS7 Linux system. In this flow, the DS7 UI is responsible for:
Displaying messages (Inbox) of the currently active user profile.
Sending targeted messages to recipients.
Displaying list of potential recipients.
Allowing broadcast of a message to all recipients.
Editing the predefined list of message content and replies that a user can choose between when sending a message.

IoT Daemon: This software resides on the DS7 Linux system. In this flow, the IoT Daemon is responsible for: Securely relaying information via Message Queuing Telemetry Transport (MQTT) between the DS7 UI and the A-dec+ cloud infrastructure. It communicates with the DS7 via a local MQTT broker and the cloud via the Azure IoT Hub. MQTT is a messaging protocol that allows devices to communicate with each other and with the cloud. It can be used in the Internet of Things (IoT).

Profile Daemon: This software resides on the DS7 Linux system. In this flow, the Profile Daemon is responsible for storing DS7 profile data in the cloud via the Azure Blob Storage.

Azure Blob Storage: This is the storage container of the DS7 profile data. When profiles are created, updated or deleted, this information is relayed to Azure Event Hubs so that this can be processed by the Azure Function Application. This ultimately allows the application to update the possible list of recipients for the Intercom system.

Azure IoT Hub: This service is used to provide a secure connection between the DS7 via the IoT Daemon software and the broader A-dec+ cloud infrastructure via MQTT. It allows the communication of targeted messages between the DS7 device and the A-dec+ cloud infrastructure. These messages from a DS7device when routed through the IoT Hub are placed on to a queuing system to be processed, provided via Azure Event Hubs.

Azure Event Hub: This service is used to:
Provide a scalable working queue of device messages received by the IoT Hub.
Provide an interface, when an event is processed, for other cloud resources to read the data.

In this flow, the Event Hub is a queue used to process events related to message data from the DS7 device, and from the Azure Blob Storage. The Azure Function Application will be triggered by data processed from these Event Hubs.

PostgreSQL Database: For this flow, it is used to:
Store the list of recipients provided by the partner system.
Store the list of recipients as defined by the A-dec+ profiles.
Store a master list of both recipients for an A-dec+ clinic account.
Store the messages sent.
Store the predefined message and reply content.
Store an indication that a Partner System account has been integrated with an A-dec+ clinic account.

Azure Function Application: This is a custom-made set of functions hosted with an Azure function Application. This is used to:
Process the data from the Event Hubs, store data in the Postgres database, provide business logic, and send data to the relevant recipient either being one or many DS7 devices, or the Partner System.
Manages the independent internal A-dec+ and external Partner system recipients, and provides each platform a unified recipient list. When receiving a message, the application will determine what platforms that recipient may receive the message based on their integration and online status, and relay the message to the individual at those platform(s).

B2C Identity Service: this service is custom configured to:
Provide identity management and access controls for the Intercom system.
Allow the secure integration of the 3rd party Partner system with an A-dec+ clinic account.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

What is claimed is:

1. A communication system, comprising:
a first user interface (UI) device registered to a first operatory, wherein the first UI device comprises a memory configured to store instructions and a processor configured to execute the instructions to:
provide a menu of a plurality of messages to a first staff member; and
based on a command from the first staff member, send a selected message of the plurality of messages to a second UI device of a second staff member, wherein the selected message automatically identifies the first operatory.

2. The communication system of claim 1, wherein the first staff member is logged into the first UI device, and the selected message automatically identifies the first staff member.

3. The communication system of claim 1, wherein the second UI device is in a third-party messaging system, and the first UI device is configured to communicate with the second UI device via a cloud platform.

4. The communication system of claim 1, wherein the second UI device is configured to provide a menu of one or more reply messages to the second staff member, and based on a command from the second staff member, send one of the reply messages to the first UI device.

5. The communication system of claim 1, wherein the menu is based on a profile of the first staff member.

6. The communication system of claim 1, wherein the menu is based on a profile of the second staff member.

7. The communication system of claim 1, wherein the menu is based on a dental procedure performed at the first operatory.

8. The communication system of claim 1, wherein the menu is based on a profile of a patient in the first operatory.

9. The communication system of claim 1, wherein the menu is based on a scheduling system that indicates a dental procedure to be performed at the first operatory.

10. The communication system of claim 1, wherein the menu is based on an identity of the first operatory and one or more associated procedures.

11. The communication system of claim 1, wherein the first UI device is configured to receive free-form text from the first staff member.

12. A communication system, comprising:
a first user interface (UI) device registered to a first operatory; and
an occupancy sensor in the first operatory, coupled to the first UI device, wherein the UI device is configured to automatically send a message based on the occupancy sensor, and the message identifies the first operatory.

13. The communication system of claim 12, wherein the occupancy sensor comprises a chair sensor.

14. The communication system of claim 12, wherein the occupancy sensor comprises a motion sensor.

15. The communication system of claim 12, wherein the message indicates a time until a next appointment at the first operatory.

16. A computer-implemented method, comprising:
display a menu of a plurality of predefined messages on a first UI device in a first operatory, wherein the plurality of predefined messages include a message indicating that a patient is ready for an examination;
receiving a selection of a selected message of the plurality of predefined messages via the first UI device;
automatically including an identifier of the first operatory with the selected message; and
sending the selected message with the identifier to a second UI device in a second operatory.

17. The computer-implemented method of claim 16, further comprising automatically including an identifier with the selected message of a staff member from which the selection was received, wherein the identifier is based on a login of the staff member into the first UI device.

18. The computer-implemented method of claim 16, wherein the plurality of predefined messages comprise a message indicating that the patient is ready for a procedure.

19. The computer-implemented method of claim 16, wherein the plurality of predefined messages comprise a message indicating that the patient is numb.

20. The computer-implemented method of claim 16, wherein the plurality of predefined messages comprise a message indicating that an urgent condition is present.
